(19) United States
(12) Patent Application Publication
(10) Pub. No.: US 2026/0162353 A1
(43) Pub. Date: Jun. 11, 2026

(54) METHOD FOR EFFECT PROCESSING, ELECTRONIC DEVICE AND STORAGE MEDIUM

(71) Applicant: Beijing Zitiao Network Technology Co., Ltd., Haidian District, Beijing (CN)

(72) Inventor: Yubin YU, Beijing (CN)

(21) Appl. No.: 19/127,219

(22) PCT Filed: Nov. 3, 2023
(86) PCT No.: PCT/CN2023/129539

§ 371 Date: May 5, 2025

(30) Foreign Application Priority Data
Nov. 4, 2022 (CN) 202211379284.0

(51) Int. Cl. G06T 15/06; G06T 3/60; G06T 5/20; G06T 7/13; G06T 15/20

(52) U.S. Cl. CPC G06T 15/06; G06T 3/60; G06T 5/20; G06T 7/13; G06T 15/205; G06T 2210/16

(57) ABSTRACT

The present disclosure provides a method for effect processing, an electronic device and a storage medium. And the method includes: in response to an effect triggering operation, obtaining an image to be processed, and displaying a first effect image in which a plurality of effect light rays divergently act on an effect acting object in the image to be processed; and adjusting the effect light rays when change occurs for object display information of the effect acting object, and displaying a second effect image in which the adjusted effect light rays act on the effect acting object.

The present application claims the priority and benefit of Chinese Patent Application No. 202211379284.0 filed on Nov. 4, 2022, the disclosure of which is incorporated by reference herein in its entirety as part of the present application.

### TECHNICAL FIELD

Embodiments of the present disclosure relate to a method for effect processing, an apparatus, a device, and a storage medium.

### BACKGROUND

With the development of the image processing technology, visual effects of an image can be enriched by adding effect light rays to the image, and watching experience of a user can be enhanced.

In the related art, in order to guarantee a relative showing effect of an image to light rays, specific processing is often performed on a single image. When the image is replaced, a new effect image needs to be made manually by a professional, which may waste time and energy with poor time effectiveness.

### SUMMARY

The present disclosure provides a method for effect processing, an apparatus, a device, and a storage medium to process an effect in real time and show the processed effect in real time with a reduced effect processing cost.

In a first aspect, an embodiment of the present disclosure provides a method for effect processing, including:
in response to an effect triggering operation, obtaining an image to be processed, and displaying a first effect image in which a plurality of effect light rays divergently act on an effect acting object in the image to be processed; and
adjusting the effect light rays when change occurs for object display information of the effect acting object, and displaying a second effect image in which the adjusted effect light rays act on the effect acting object.

In a second aspect, an embodiment of the present disclosure provides an apparatus for effect processing, including:
a first effect image display module configured to, in response to an effect triggering operation, obtain an image to be processed, and display a first effect image in which a plurality of effect light rays divergently act on an effect acting object in the image to be processed; and
a second effect image display module configured to adjust the effect light rays when change occurs for object display information of the effect acting object, and display a second effect image in which the adjusted effect light rays act on the effect acting object.

In a third aspect, an embodiment of the present disclosure further provides an electronic device, including:
one or more processors; and
a storage apparatus configured to store one or more programs,
in which the one or more programs, when executed by the one or more processors, cause the one or more processors to implement the method for effect processing as described in any of the embodiments of the present disclosure.

In a fourth aspect, an embodiment of the present disclosure further provides a storage medium including computer executable instructions, in which the computer executable instructions, when executed by a computer processor, cause the method for effect processing as described in any of the embodiments of the present disclosure to be performed.

### BRIEF DESCRIPTION OF DRAWINGS

The above and other features, advantages and aspects of different embodiments of the present disclosure will become more apparent from the accompanying drawings and the following specific embodiments. Identical or similar reference numerals indicate identical or similar elements throughout the drawings. It will be understood that the drawings are illustrative, and components and elements are not necessarily drawn to scale.

FIG. 1 is a flowchart of a method for effect processing provided by an embodiment of the present disclosure;

FIG. 2 is a flowchart of another effect processing method provided by an embodiment of the present disclosure;

FIG. 3 is a schematic diagram of another effect processing method provided by an embodiment of the present disclosure;

FIG. 4 is a flowchart of a further another effect processing method provided by an embodiment of the present disclosure;

FIG. 5 is a structural schematic diagram of an apparatus for effect processing provided by an embodiment of the present disclosure; and

FIG. 6 is a structural schematic diagram of an electronic device provided by an embodiment of the present disclosure.

### DETAILED DESCRIPTION

Embodiments of the present disclosure will be described below in more detail with reference to the accompanying drawings. While the accompanying drawings show some embodiments of the present disclosure, it will be understood that the present disclosure may be implemented in various forms and should not be construed as being limited to the embodiments set forth herein. Rather, these embodiments are provided so that the present disclosure can be understood more thoroughly and comprehensively. It should be understood that the accompanying drawings and the embodiments of the present disclosure are only used as examples, and are not intended to limit the protection scope of the present disclosure.

It will be understood that steps described in the method implementations of the present disclosure may be performed in different orders and/or concurrently. In addition, the method implementations may include additional steps and/or the steps shown may be omitted. The scope of the present disclosure is not limited in this aspect.

As used herein, the term “include” and variants thereof are open words and should be construed as “including but not limited to”. The term “based on” means “at least in part based on”. The term “one embodiment” represents “at least one embodiment”; the term “another embodiment” represents “at least one further embodiment”; and the term “some embodiments” represents “at least some embodiments”. The relevant definitions of other terms will be given in the following descriptions.

Names of messages or information exchanged between a plurality of apparatuses in embodiments of the present disclosure are only used for the purpose of description and not meant to limit the scope of these messages or information.

FIG. 1 is a flowchart of a method for effect processing provided by an embodiment of the present disclosure. This embodiment of the present disclosure is applicable to a scenario of enriching effect light rays for an image and/or a video. The method for effect processing may be performed by an apparatus for effect processing and may be specifically configured in effect processing application software. The apparatus for effect processing may be implemented in the form of software and/or hardware and optionally implemented by an electronic device. The electronic device may be a mobile terminal, a personal computer (PC), a server, or the like.

As shown in FIG. 1, the method for effect processing of the present embodiment may include the following steps.

S101, in response to an effect triggering operation, obtain an image to be processed, and display a first effect image in which a plurality of effect light rays divergently act on an effect acting object in the image to be processed.

In an embodiment of the present disclosure, an image or a video frame of which effect light rays are to be enriched may be determined as the image to be processed. The effect acting object may be an object associated with the effect light rays in the image to be processed. For example, the effect acting object may be an object needing to be added with the effect light rays or an object having a linkage effect with the effect light rays. Exemplarily, the effect acting object may be at least part of a region of an image subject in the image to be processed. In other words, the effect acting object may include all the region of one or more image subjects in the image to be processed, or may be part of regions of one or more image subjects in the image to be processed. For example, when the image subject in the image to be processed is a building, the effect acting object may be the whole region of the building. The effect acting object may include at least one selected from the group of doors and windows, steps, props, and building contours. When the image subject in the image to be processed is a human body, the effect acting object may be the entire human body region. The effect acting object may also include at least one selected from the group of face, eyes, mouth, ears, shoulders, hair, clothes, and accessories. The first effect image may refer to the image to be processed on which effect light ray effect has been performed. The first effect image includes a plurality of divergent effect light rays that act on the effect acting object in the image to be processed.

The display information of the effect light rays may be set according to an actual requirement of a user. For example, information such as a color, a brightness, a thickness, and a number of the effect light rays may be set. In an embodiment of the present disclosure, the plurality of effect light rays may be displayed divergently. A light emitting effect of the image subject is simulated in the form of divergent light.

The effect triggering operation may be construed as an operation that, after being performed, can trigger the system to activate the light effect and show the first effect image. It can be appreciated that there may be a plurality of generation ways for the effect triggering operation. For example, the effect triggering operation may be generated by voice information, gesture information, a preset time condition, a preset effect triggering control, etc. The effect triggering control may be a virtual identifier set on a software interface. The triggering the effect triggering control may be used to represent showing an image in a preset effect manner. In an embodiment of the present disclosure, a light effect showing effect may be applied for an effect acting subject in the image to be processed and then the image is shown.

Exemplarily, the effect triggering operation input for the image to be processed is received, which may include at least one selected from the group of the following operations: receiving voice information containing a target keyword; obtaining preset gesture information; receiving a tapping operation or a pressing operation input for a preset image showing control; detecting preset image information included in the image to be processed, etc. The preset image information may be a preset image subject, such as a human body, a text, a pattern, a building, flowers and trees.

As an optional solution of the embodiments of the present disclosure, the effect triggering operation may be generated by uploading or shooting an image. Exemplarily, receiving the effect triggering operation input for the image to be processed may specifically include: receiving a control triggering operation acting on a preset effect triggering control, and showing an image acquisition interface, in which the image acquisition interface includes an image uploading control; and determining an operation of uploading the image to be processed based on the image uploading control as the effect triggering operation.

Optionally, obtaining the image to be processed includes: shooting the image to be processed by an image pickup apparatus, or determining the image to be processed according to a pre-stored image, or capturing a video frame from a shown video as the image to be processed.

In an embodiment of the present disclosure, in response to the effect triggering operation triggered by a user, the image to be processed is obtained first, and then the image to be processed is processed to obtain an effect image after the effect light rays are added to the image to be processed, i.e., the first effect image. The first effect image is then shown for the user.

In order to guarantee the showing effect of the first effect image, optionally, after the obtaining the image to be processed, the method for effect processing further includes: performing filtering processing on the image to be processed based on a guided filtering algorithm. The image to be processed is denoised using the guided filtering algorithm such that a lot of image noise occurring in the subsequent processing process of the image to be processed is reduced, thus guaranteeing the final effect. For example, a lot of image noise occurring in an edge detection process of the image to be processed can be reduced.

S102, adjust the effect light rays when change occurs for object display information of the effect acting object, and display a second effect image in which the adjusted effect light rays act on the effect acting object.

The object display information may refer to display information of the effect acting object in the image to be processed. Optionally, the object display information includes, but is not limited to, a display state and/or a rotation angle. For example, the object display information may further include information such as a display color of the effect acting object.

The display state may include a display size and/or a display form, etc. Exemplarily, when the effect acting object is a hand, the display state may refer to splaying out or gripping of fingers, and the rotation angle may refer to a rotation angle of a palm. When the effect acting object is a face, the display state may refer to opening and closing of eyes, and the rotation angle may refer to a rotation angle of a head. When the effect acting object is a plant, the display state may refer to a height of the plant in the image to be processed.

The second effect image may be construed as an effect image obtained after the effect light rays are changed and adjusted according to the object display information. It can be appreciated that the display information of the effect light rays in the second effect image is not completely identical to the display information of the effect light rays in the first effect image.

Specifically, upon detecting that the object displays information of the effect acting object changes, the effect light rays are adjusted according to the change of the object display information of the effect acting object, and the adjusted effect light rays act on the effect acting object to obtain the second effect image.

In an embodiment of the present disclosure, adjusting the effect light rays may be construed as adjusting light ray display information of the effect light rays. The light ray display information includes, but is not limited to, at least one selected from the group of information such as a color, a length, and a display position.

It needs to be noted that the changing of the object displays information of the effect acting object may be changing of an image subject corresponding to the effect acting object. For example, a person in the image to be processed changes from A to B or from A to A and B, etc. Alternatively, part of a subject region of the image subject corresponding to the effect acting object changes. For example, the person in the image to be processed changes from directly facing the lens to laterally facing the lens, etc.

With the technical solution of this embodiment of the present disclosure, in response to the effect triggering operation, the image to be processed is obtained, and the first effect image in which a plurality of effect light rays divergently act on the effect acting object in the image to be processed is displayed. The effect of divergent light can be presented. The display forms of the image are enriched. The visual experience of the user is enhanced. When change occurs for object display information of the effect acting object, the effect light rays are adjusted in real time, and the second effect image in which the adjusted effect light rays act on the effect acting object is displayed in real time. The technical problems of wasting time and energy and poor time effectiveness caused by manually generating an effect image in the related art are solved. Linkage of the effect light rays and the effect acting object can be realized. Diversified showing of the effect light rays is enabled. The flexibility and interestingness of the image effect are improved. The image display effect is further improved. The visual experience of the user is enriched.

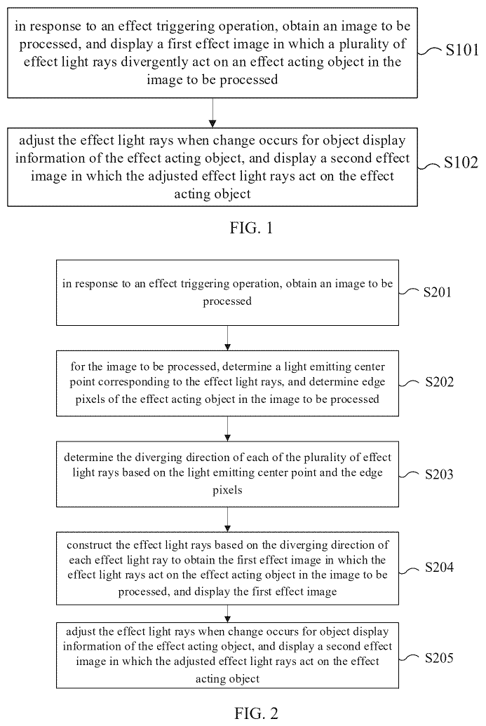

FIG. 2 is a flowchart of another effect processing method provided by an embodiment of the present disclosure. On the basis of the above embodiment, the technical solution of this embodiment is to further detail how a first effect image in which a plurality of effect light rays divergently act on an effect acting object in an image to be processed is displayed. The specific implementation may be as described as in the present embodiment. The technical features identical or similar to those in the foregoing embodiments will not be repeatedly described.

As shown in FIG. 2, the method for effect processing of the present embodiment may specifically include the following steps.

S201, in response to an effect triggering operation, obtain an image to be processed.

S202, for the image to be processed, determine a light emitting center point corresponding to the effect light rays, and determine edge pixels of the effect acting object in the image to be processed.

The light emitting center point may be construed as a light source point for emanating a plurality of divergent effect light rays. In an embodiment of the present disclosure, the light emitting center point may be set according to an actual requirement. Exemplarily, the light emitting center point may be a point in the image to be processed, which may be specifically, for example, a center point of the image to be processed or a preset feature point in the image to be processed, etc.

Optionally, determining the light emitting center point corresponding to the effect light rays includes: performing image recognition on the image to be processed based on a preset image recognition algorithm to determine a target image subject in the image to be processed; and determining the light emitting center point corresponding to the effect light rays based on the target image subject. There may be one or more preset image recognition algorithms. Exemplarily, the image recognition algorithm may be at least one selected from the group of algorithms such as a face recognition algorithm, a recognition algorithm for preset organs (nose, eyebrows, eyes, mouth, etc.) in the face, and a vehicle license plate recognition algorithm.

Optionally, determining the light emitting center point corresponding to the effect light rays based on the target image subject includes: determining a center pixel of the target image subject, and determining the center pixel as the light emitting center point corresponding to the effect light rays.

Optionally, determining the light emitting center point corresponding to the effect light rays based on the target image subject includes: obtaining a template image corresponding to the target image subject, in which the template image is marked with at least one template key point; performing image alignment on the template image and the target image subject, determining a subject key point of the target image subject based on the template key point in the aligned template image, and determining the light emitting center point corresponding to the effect light rays based on the subject key point.

Further, when one subject key point is determined, the subject key point may be used as the light emitting center point corresponding to the effect light rays. When a plurality of subject key points are determined, any subject key point or a subject key point arranged at a preset position may be used as the light emitting center point corresponding to the effect light rays.

The edge pixels may refer to pixels corresponding to a contour of the effect acting object. Specifically, the edge pixels may be pixels corresponding to an external contour of the effect acting object.

Optionally, an edge is extracted from the effect acting object in the image to be processed according to a preset image edge algorithm or a pre-trained edge detection model, and the edge pixels of the effect acting object are determined according to an edge extraction result.

Specifically, for the image to be processed, the light emitting center point corresponding to the effect light rays in the image to be processed is determined. The external contour of the effect acting object in the image to be processed is determined according to the image edge algorithm, and each edge pixel corresponding to the external contour of the effect acting object is determined.

S203, determine the diverging direction of each of the plurality of effect light rays based on the light emitting center point and the edge pixels.

The diverging direction may be construed as a direction in which the effect light ray runs. In an embodiment of the present disclosure, the diverging direction of each effect light ray may be determined according to the position information of the light emitting center point and the position information of the edge pixel. Specifically, a direction from the light emitting center point to the edge pixel may be used as the diverging direction of the effect light ray at the edge pixel.

In an embodiment of the present disclosure, to make the effect light ray three-dimensional, unlike the way of processing with two-dimensional coordinates of an image in the related art, the two-dimensional coordinates are converted to three-dimensional coordinates for processing. Exemplarily, the determining the diverging direction of each of the plurality of effect light rays based on the light emitting center point and the edge pixels includes: for each edge pixel to be processed of the edge pixels of the effect acting object, determining a three-dimensional center point coordinate of the light emitting center point and a three-dimensional edge point coordinate of the edge pixel; and determining the diverging direction of the effect light ray corresponding to the edge pixel based on the three-dimensional center point coordinate and the three-dimensional edge point coordinate.

The edge pixel to be processed may be construed as an edge pixel at which the effect light ray is to be constructed. Optionally, the edge pixel to be processed is determined from the edge pixels of the effect acting object. Exemplarily, each edge pixel of the effect acting object may be used as the edge pixel to be processed, or the edge pixel to be processed may be determined from the edge pixels of the effect acting object according to a preset selection rule. The preset selection rule may be at least one selected from the group of rules such as sequentially selecting according to a preset number of pixels, selecting by a position of a pixel, or random selecting.

In an embodiment of the present disclosure, the selection rule may be set according to an actual requirement, which will not be specifically defined here. For example, sequentially selecting according to a preset number of pixels may be specifically selecting a second preset number of edge pixels at intervals of a first preset number, or with an edge pixel at a preset position as a starting point, sequentially selecting a preset number of edge pixels according to a preset direction, or randomly selecting a preset number of pixels, etc.

The three-dimensional center point coordinate may refer to a coordinate obtained by mapping the coordinate of the light emitting center point in a two-dimensional space to a three-dimensional space. Similarly, the three-dimensional edge point coordinate may refer to a coordinate obtained by mapping the coordinate of the edge pixel in the two-dimensional space to the three-dimensional space.

Specifically, for each edge pixel to be processed of the edge pixels of the effect acting object, the three-dimensional edge point coordinate of the edge pixel in the three-dimensional space are determined, and the three-dimensional center point coordinate of the light emitting center point in the three-dimensional space are determined. The diverging direction of the effect light ray corresponding to the light emitting center point and the edge pixel is determined based on the three-dimensional center point coordinate and the three-dimensional edge point coordinate.

Exemplarily, the determining a three-dimensional center point coordinate of the light emitting center point and a three-dimensional edge point coordinate of the edge pixel includes: when the image to be processed is a two-dimensional image, based on preset depth information, converting a two-dimensional center point coordinate of the light emitting center point to the three-dimensional center point coordinate, and converting a two-dimensional edge point coordinate of the edge pixel to the three-dimensional edge point coordinate.

The preset depth information may be preset. The preset depth information is used for adding depth information to two-dimensional coordinate such that the two-dimensional coordinate is converted to three-dimensional coordinate. The preset depth information may be a preset depth value, or a preset reference depth value of a reference pixel in the image to be processed and depth change information between pixels. It needs to be noted that depth information corresponding to different pixels may be the same or may be different.

As described previously, the image to be processed in the embodiments of the present disclosure is a two-dimensional image. In order to determine the change of the object display information of the effect acting object, the preset depth information may be given to the two-dimensional center point coordinate of the light emitting center point such that the two-dimensional center point coordinate is converted to three-dimensional center point coordinate, and the preset depth information may be given to the two-dimensional edge point coordinates of the edge pixel such that the two-dimensional edge point coordinates are converted to three-dimensional edge point coordinate.

S204, construct the effect light rays based on the diverging direction of each effect light ray to obtain the first effect image in which the effect light rays act on the effect acting object in the image to be processed, and display the first effect image.

In an embodiment of the present disclosure, constructing the effect light ray based on the diverging direction of each effect light ray may include: taking the edge pixel as a starting display position, constructing the effect light ray along the diverging direction. Thus, the effect that the light emitting center point is a light source and the effect light rays diverge to four sides is simulated. Further, in order to simulate the light propagation properties, changing in intensity of the effect light rays in the diverging process may also be simulated. For example, along a direction away from the edge pixel point in the diverging direction, the light intensity of the effect light ray may be presented as being weakened gradually.

Optionally, the constructing the effect light ray based on the diverging direction of each effect light ray further includes: construct the effect light ray along the diverging direction according to a preset initial light intensity and an attenuation factor corresponding to the light intensity, take the edge pixel as a starting display position.

The preset light intensity may refer to a luminous intensity of a preset effect light ray at the light emitting center point or the edge pixel. The attenuation factor may be construed as a factor for measuring a change in light intensity of the effect light ray. Exemplarily, the attenuation factor may be an attenuation value of the light intensity along the diverging direction or an attenuation ratio of the light intensity, etc. It can be appreciated that specific values of the preset light intensity and the attenuation factor may be set according to an actual requirement, which will not be specifically defined here.

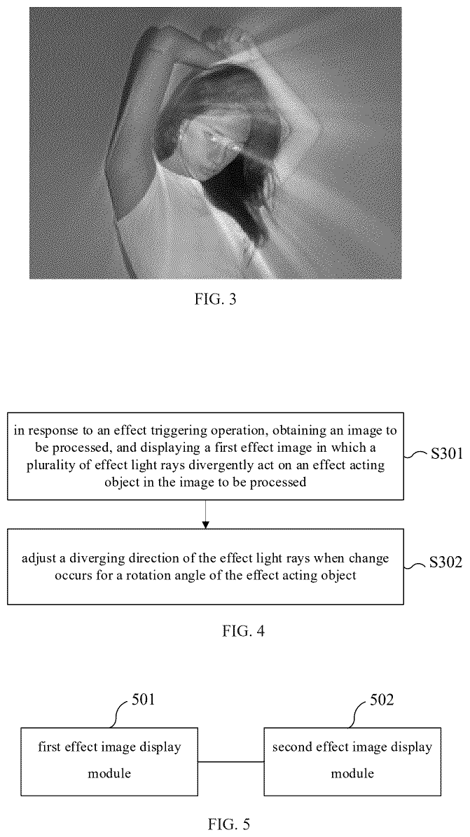

Specifically, as shown in FIG. 3, the edge pixel may be determined as the starting display position of the effect light ray, and the effect light ray consistent with the diverging direction may be constructed according to the preset initial light intensity and the attenuation factor corresponding to the light intensity. Thus, the visual effect of the effect light ray is improved.

In an embodiment of the present disclosure, the effect light rays may be constructed according to the diverging directions of the effect light rays first, and then the effect light rays act on the effect acting object in the image to be processed to obtain the first effect image, and the first effect image is displayed for the user. Optionally, the effect light rays acting on the effect acting object in the image to be processed includes: replacing pixel values of image pixels corresponding to the effect light rays in the image to be processed with pixel values of light pixels of the effect light rays; or, performing fusion processing on the pixel values of the t pixels of the effect light rays and the pixel values of the image pixels corresponding to the effect light rays in the image to be processed. The fusion processing includes at least one selected from the group of summation processing, weighted summation processing, and multiplication or weighted multiplication processing.

S205, adjust the effect light rays when change occurs for object display information of the effect acting object, and display a second effect image in which the adjusted effect light rays act on the effect acting object.

According to the technical solutions of the embodiments of the present disclosure, for the image to be processed, the light emitting center point corresponding to the effect light rays is determined, and the edge pixels of the effect acting object in the image to be processed are determined. The diverging direction of each of the plurality of effect light rays is determined based on the light emitting center point and the edge pixels. The effect light ray is constructed based on the diverging direction of each effect light ray to obtain the first effect image in which the effect light rays act on the effect acting object in the image to be processed, and the first effect image is displayed. Thus, the effect light rays can be automatically generated for the image to be processed in real time. The effect processing efficiency is improved. The labor cost of effect processing is reduced, and the effect displaying is enhanced. The visual experience of the user is enriched.

FIG. 4 is a flowchart of another effect processing method provided by an embodiment of the present disclosure. On the basis of the above embodiment, the technical solution of this embodiment is to further detail how to adjust effect light rays when change occurs for object display information of the effect acting object. The specific implementation may be as described as in the present embodiment. The technical features identical or similar to those in the foregoing embodiments will not be repeatedly described.

As shown in FIG. 4, the text processing method of the present embodiment may specifically include the following steps.

S301, in response to an effect triggering operation, obtaining an image to be processed, and displaying a first effect image in which a plurality of effect light rays divergently act on an effect acting object in the image to be processed.

S302, adjust a diverging direction of the effect light rays when change occurs for a rotation angle of the effect acting object.

The rotation angle may be construed as depth information of at least part of pixels in the effect acting object in a current image to be processed changing as compared with its depth information in a previous image to be processed.

Specifically, when the rotation angle of the effect acting object changes, the rotation angle of the effect acting object can be determined first, and then the diverging direction of the effect light ray can be adjusted based on the rotation angle. for example, when the head rotates leftwards, a rotation angle of the head when rotating leftwards is determined, and the diverging direction of the effect light ray is adjusted according to the leftward rotation angle.

Exemplarily, the adjusting a diverging direction of the effect light ray includes: determining the rotation angle of the effect acting object, and determining a rotation matrix of the effect acting object in a three-dimensional space based on the rotation angle; and determining an adjusted diverging direction of the effect light ray according to a current diverging direction of the effect light ray and the rotation matrix.

The rotation angle corresponding to the effect acting object may be determined according to the rotation information of the effect acting object based on a preset rotation angle algorithm or a rotation angle detection apparatus configured in a terminal. Thus, the rotation matrix of the effect acting object in the three-dimensional space can be determined according to the rotation angle. Finally, according to the rotation matrix, the current diverging direction of the effect light ray is adjusted according to the rotation matrix, and the diverging direction of the effect light ray after direction adjustment is determined.

Exemplarily, the determining an adjusted diverging direction of the effect light ray according to a current diverging direction of the effect light ray and the rotation matrix includes: when the image to be processed is a two-dimensional image, determining a direction vector of the current diverging direction of the effect light ray in the three-dimensional space; and multiplying the direction vector by the rotation matrix to obtain an adjusted direction vector of the effect light ray, and mapping the direction vector to a two-dimensional space to obtain the diverging direction of the effect light ray.

Specifically, when the image to be processed is a two-dimensional image, the direction vector of the current diverging direction of the effect light ray in the three-dimensional space is determined according to the three-dimensional center point coordinate and the three-dimensional edge point coordinate. Multiplication operation processing is performed on the direction vector and the rotation matrix, and a result of the multiplication operation processing is determined as the adjusted direction vector of the effect light ray. The adjusted direction vector is mapped from the three-dimensional space to the two-dimensional space such that the adjusted diverging direction of the effect light ray is obtained. Thus, the two-dimensional image is enabled to have three-dimensional effect light rays.

According to the technical solutions of the embodiments of the present disclosure, when the rotation angle of the effect acting object changes, the diverging direction of the effect light ray can be adjusted according to the rotation angle of the effect acting object. On the basis of the original effect light rays, the effect light rays are converted to guarantee the relative display effect of the effect light rays to the effect acting object. The adjustment efficiency of the effect light rays is improved. The interaction experience of the user is enhanced.

FIG. 5 is a structural schematic diagram of an apparatus for effect processing provided by an embodiment of the present disclosure. As shown in FIG. 5, the apparatus for effect processing includes a first effect image display module 501 and a second effect image display module 502.

The first effect image display module 501 is configured to, in response to an effect triggering operation, obtain an image to be processed, and display a first effect image in which a plurality of effect light rays divergently act on an effect acting object in the image to be processed; and the second effect image display module 502 is configured to adjust the effect light rays when change occurs for object display information of the effect acting object, and display a second effect image in which the adjusted effect light rays act on the effect acting object.

With the technical solution of this embodiment of the present disclosure, in response to the effect triggering operation, the image to be processed is obtained, and the first effect image in which a plurality of effect light rays divergently act on the effect acting object in the image to be processed is displayed. The effect of divergent light can be presented. The display forms of the image are enriched. The visual experience of the user is enhanced. When change occurs for object display information of the effect acting object, the effect light rays are adjusted in real time, and the second effect image in which the adjusted effect light rays act on the effect acting object is displayed in real time. The technical problems of wasting time and energy and poor time effectiveness caused by manually generating an effect image in the related art are solved. Linkage of the effect light rays and the effect acting object can be realized. Diversified showing of the effect light rays is enabled. The flexibility and interestingness of the image effect are improved. The image display effect is further improved. The visual experience of the user is enriched.

On the basis of the above embodiments, the object display information includes a rotation angle.

Correspondingly, the second effect image display module 502 may include a rotation angle adjustment unit. The rotation angle adjustment unit is configured to adjust a diverging direction of the effect light ray when the rotation angle of the effect acting object changes.

On the basis of the above embodiments, the first effect image display module 501 may include a light emitting center point determination unit, a diverging direction determination unit, and a first effect image unit.

The light emitting center point determination unit is configured to, for the image to be processed, determine a light emitting center point corresponding to the effect light rays, and determine edge pixels of the effect acting object in the image to be processed. The diverging direction determination unit is configured to determine the diverging direction of each of the plurality of effect light rays based on the light emitting center point and the edge pixels. The first effect image unit is configured to construct the effect light ray based on the diverging direction of each effect light ray to obtain the first effect image in which the effect light rays act on the effect acting object in the image to be processed, and display the first effect image.

On the basis of the above embodiments, the diverging direction determination unit may include a three-dimensional coordinate determination subunit and a diverging direction determination subunit.

The three-dimensional coordinate determination subunit is configured to, for each edge pixel to be processed of the edge pixels of the effect processing object, determine a three-dimensional center point coordinate of the light emitting center point and a three-dimensional edge point coordinate of the edge pixel. The diverging direction determination subunit is configured to determine the diverging direction of the effect light ray corresponding to the edge pixel based on the three-dimensional center point coordinate and the three-dimensional edge point coordinate.

On the basis of the above embodiments, the three-dimensional coordinate determination subunit is configured to, when the image to be processed is a two-dimensional image, based on preset depth information, convert a two-dimensional center point coordinate of the light emitting center point to the three-dimensional center point coordinate, and convert a two-dimensional edge point coordinate of the edge pixel to the three-dimensional edge point coordinate.

On the basis of the above embodiments, the first effect image unit may be specifically configured to, construct the effect light ray along the diverging direction according to a preset initial light intensity and an attenuation factor corresponding to the light intensity, take the edge pixel as a starting display position.

On the basis of the above embodiments, the rotation angle adjustment unit may include a rotation matrix determination subunit and a diverging direction determination subunit.

The rotation matrix determination subunit is configured to determine the rotation angle of the effect acting object, and determine a rotation matrix of the effect acting object in a three-dimensional space based on the rotation angle. The diverging direction determination subunit is configured to determine an adjusted diverging direction of the effect light ray according to a current diverging direction of the effect light ray and the rotation matrix.

On the basis of the above embodiments, the diverging direction determination subunit may be specifically configured to: when the image to be processed is a two-dimensional image, determine a direction vector of the current diverging direction of the effect light ray in the three-dimensional space; and multiply the direction vector by the rotation matrix to obtain an adjusted direction vector of the effect light ray, and map the direction vector to a two-dimensional space to obtain the diverging direction of the effect light ray.

On the basis of the above embodiments, optionally, the apparatus for effect processing further includes:
a guided filtering module configured to, after the obtaining the image to be processed, perform filtering processing on the image to be processed based on a guided filtering algorithm.

On the basis of the above embodiments, exemplarily, the effect acting object may include at least one selected from the group of face, eyes, mouth, ears, shoulders, hair, clothes, and accessories.

The apparatus for effect processing provided by the embodiment of the present disclosure may perform the method for effect processing provided by any embodiment of the present disclosure and has corresponding functional modules for performing the method for effect processing and corresponding beneficial effects.

It needs to be noted that the units and modules included in the apparatus described above are only divided according to functional logic, but are not limited to the above division, as long as corresponding functions can be implemented. In addition, names of the functional units are merely for the purpose of distinguishing from each other, but are not intended to limit the protection scope of the embodiments of the present disclosure.

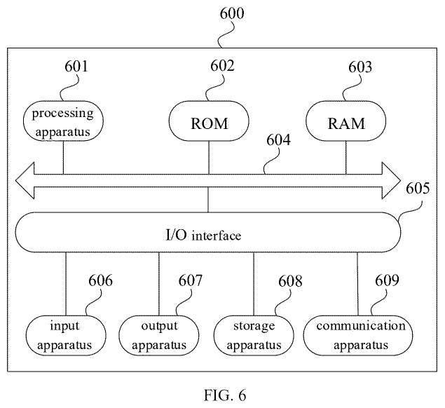

FIG. 6 is a structural schematic diagram of an electronic device provided by an embodiment of the present disclosure. Referring to FIG. 6, FIG. 6 illustrates a schematic structural diagram of an electronic device (for example a terminal device or a server in FIG. 6) 600 suitable for implementing some embodiments of the present disclosure. The terminal devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 6 is merely an example, and should not pose any limitation to the functions and the range of use of the embodiments of the present disclosure.

As illustrated in FIG. 6, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 6 illustrates the electronic device 600 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

Names of messages or information exchanged between a plurality of apparatuses in embodiments of the present disclosure are only used for the purpose of description and not meant to limit the scope of these messages or information.

The electronic device provided in this embodiment of the present disclosure and the method for effect processing provided in the foregoing embodiments belong to the same inventive concept. For technical details not described in detail in this embodiment, a reference may be made to the foregoing embodiments, and this embodiment and the foregoing embodiments have the same beneficial effects.

An embodiment of the present disclosure provides a computer storage medium, storing a computer program which, when executed by a processor, implements the method for effect processing provided by the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs which, when executed by the electronic device, cause the electronic device to: in response to an effect triggering operation, obtain an image to be processed, and display a first effect image in which a plurality of effect light rays divergently act on an effect acting object in the image to be processed; and adjust the effect light rays when change occurs for object display information of the effect acting object, and display a second effect image in which the adjusted effect light rays act on the effect acting object.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

Related units described in the embodiments of the present disclosure may be implemented by software, or may be implemented by hardware. The name of a unit does not constitute a limitation on the unit itself. For example, a first acquisition unit may also be described as “a unit for obtaining at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example 1 provides a method for effect processing, including:
in response to an effect triggering operation, obtaining an image to be processed, and displaying a first effect image in which a plurality of effect light rays divergently act on an effect acting object in the image to be processed; and
adjusting the effect light rays when change occurs for object display information of the effect acting object, and displaying a second effect image in which the adjusted effect light rays act on the effect acting object.

According to one or more embodiments of the present disclosure, Example 2 provides the method for effect processing of Example 1, in which:
optionally, the object display information includes a rotation angle; and the adjusting the effect light rays when change occurs for object display information of the effect acting object includes:
adjusting a diverging direction of the effect light ray when the rotation angle of the effect acting object changes.

According to one or more embodiments of the present disclosure, Example 3 provides the method for effect processing of Example 1 or Example 2, in which:
optionally, the displaying a first effect image in which a plurality of effect light rays divergently act on an effect acting object in the image to be processed includes:
for the image to be processed, determining a light emitting center point corresponding to the effect light rays, and determining edge pixels of the effect acting object in the image to be processed;
determining the diverging direction of each of the plurality of effect light rays based on the light emitting center point and the edge pixels; and
constructing the effect light ray based on the diverging direction of each effect light ray to obtain the first effect image in which the effect light rays act on the effect acting object in the image to be processed, and displaying the first effect image.

According to one or more embodiments of the present disclosure, Example 4 provides the method for effect processing of Example 3, in which:
optionally, the determining the diverging direction of each of the plurality of effect light rays based on the light emitting center point and the edge pixels includes:
for each edge pixel to be processed of the edge pixels of the effect acting object, determining a three-dimensional center point coordinate of the light emitting center point and a three-dimensional edge point coordinate of the edge pixel; and
determining the diverging direction of the effect light ray corresponding to the edge pixel based on the three-dimensional center point coordinate and the three-dimensional edge point coordinate.

According to one or more embodiments of the present disclosure, Example 5 provides the method for effect processing of Example 4, in which:
optionally, the determining a three-dimensional center point coordinate of the light emitting center point and a three-dimensional edge point coordinate of the edge pixel includes:
when the image to be processed is a two-dimensional image, based on preset depth information, converting a two-dimensional center point coordinate of the light emitting center point to the three-dimensional center point coordinate, and converting a two-dimensional edge point coordinate of the edge pixel to the three-dimensional edge point coordinate.

According to one or more embodiments of the present disclosure, Example 6 provides the method for effect processing of Example 4, in which:

Optionally, the constructing the effect light ray based on the diverging direction of each effect light ray includes:
taking the edge pixel as a starting display position, constructing the effect light ray along the diverging direction according to a preset initial light intensity and an attenuation factor corresponding to the light intensity.

According to one or more embodiments of the present disclosure, Example 7 provides the method for effect processing of Example 4, in which:
optionally, the adjusting a diverging direction of the effect light ray includes:
determining the rotation angle of the effect acting object, and determining a rotation matrix of the effect acting object in a three-dimensional space based on the rotation angle; and
determining an adjusted diverging direction of the effect light ray according to a current diverging direction of the effect light ray and the rotation matrix.

According to one or more embodiments of the present disclosure, Example 8 provides the method for effect processing of Example 7, in which:
optionally, the determining an adjusted diverging direction of the effect light ray according to a current diverging direction of the effect light ray and the rotation matrix includes:
when the image to be processed is a two-dimensional image, determining a direction vector of the current diverging direction of the effect light ray in the three-dimensional space; and
multiplying the direction vector by the rotation matrix to obtain an adjusted direction vector of the effect light ray, and mapping the direction vector to a two-dimensional space to obtain the diverging direction of the effect light ray.

According to one or more embodiments of the present disclosure, Example 9 provides the method for effect processing of Example 1, which:
optionally, after the obtaining the image to be processed, further includes:
performing filtering processing on the image to be processed based on a guided filtering algorithm.

According to one or more embodiments of the present disclosure, Example 10 provides the method for effect processing of Example 1, in which:
optionally, the effect acting object includes at least one selected from the group of face, eyes, mouth, ears, shoulders, hair, clothes, and accessories.

According to one or more embodiments of the present disclosure, Example 11 provides an apparatus for effect processing, including:
a first effect image display module configured to, in response to an effect triggering operation, obtain an image to be processed, and display a first effect image in which a plurality of effect light rays divergently act on an effect acting object in the image to be processed; and
a second effect image display module configured to adjust the effect light rays when change occurs for object display information of the effect acting object, and display a second effect image in which the adjusted effect light rays act on the effect acting object.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for effect processing, comprising:
in response to an effect triggering operation, obtaining an image to be processed, and displaying a first effect image in which a plurality of effect light rays divergently act on an effect acting object in the image to be processed; and
adjusting the effect light rays when change occurs for object display information of the effect acting object, and displaying a second effect image in which the adjusted effect light rays act on the effect acting object.

2. The method for effect processing according to claim 1, wherein the object display information comprises a rotation angle; and
the adjusting the effect light rays when change occurs for object display information of the effect acting object, comprises:
adjusting a diverging direction of the effect light rays when change occurs for a rotation angle of the effect acting object.

3. The method for effect processing according to claim 1, wherein the displaying a first effect image in which a plurality of effect light rays divergently act on an effect acting object in the image to be processed comprises:
for the image to be processed, determining a light emitting center point corresponding to the effect light rays, and determining edge pixels of the effect acting object in the image to be processed;
determining the diverging direction of each of the plurality of effect light rays based on the light emitting center point and the edge pixels; and
constructing the effect light rays based on the diverging direction of each effect light ray to obtain the first effect image in which the effect light rays act on the effect acting object in the image to be processed, and displaying the first effect image.

4. The method for effect processing according to claim 3, wherein the determining the diverging direction of each of the plurality of effect light rays based on the light emitting center point and the edge pixels comprises:
for each edge pixel to be processed of the edge pixels of the effect acting object, determining a three-dimensional center point coordinate of the light emitting center point and a three-dimensional edge point coordinate of the edge pixel; and
determining a diverging direction of an effect light ray corresponding to the edge pixel based on the three-dimensional center point coordinate and the three-dimensional edge point coordinate.

5. The method for effect processing according to claim 4, wherein the determining a three-dimensional center point coordinate of the light emitting center point and a three-dimensional edge point coordinate of the edge pixel, comprises:
when the image to be processed is a two-dimensional image, based on preset depth information, converting a two-dimensional center point coordinate of the light emitting center point to the three-dimensional center point coordinate, and converting a two-dimensional edge point coordinate of the edge pixel to the three-dimensional edge point coordinate.

6. The method for effect processing according to claim 4, wherein the constructing the effect light rays based on the diverging direction of each effect light ray comprises:
constructing the effect light ray along the diverging direction according to a preset initial light intensity and an attenuation factor corresponding to the light intensity, taking the edge pixel as a starting display position.

7. The method for effect processing according to claim 2, wherein the adjusting a diverging direction of the effect light rays comprises:
determining the rotation angle of the effect acting object, and determining a rotation matrix of the effect acting object in a three-dimensional space based on the rotation angle of the effect acting object; and
determining the adjusted diverging direction of the effect light ray according to a current diverging direction of the effect light rays and the rotation matrix.

8. The method for effect processing according to claim 7, wherein the determining the adjusted diverging direction of the effect light ray according to a current diverging direction of the effect light ray and the rotation matrix comprises:
when the image to be processed is a two-dimensional image, determining a direction vector of the current diverging direction of the effect light ray in the three-dimensional space; and
multiplying the direction vector by the rotation matrix to obtain an adjusted direction vector of the effect light ray, and mapping the direction vector to a two-dimensional space to obtain the diverging direction of the effect light ray.

9. The method for effect processing according to claim 1, wherein after the obtaining the image to be processed, the method for effect processing further comprises:
performing filtering processing on the image to be processed based on a guided filtering algorithm.

10. The method for effect processing according to claim 1, wherein the effect acting object comprises at least one selected from the group of face, eyes, mouth, ears, shoulders, hair, clothes, and accessories.

11. (canceled)

12. An electronic device, comprising:
one or more processors; and
a storage apparatus configured to store one or more programs,
wherein the one or more programs, when executed by the one or more processors, cause the one or more processors to implement a method for effect processing, and the method comprises:
in response to an effect triggering operation, obtaining an image to be processed, and displaying a first effect image in which a plurality of effect light rays divergently act on an effect acting object in the image to be processed; and
adjusting the effect light rays when change occurs for object display information of the effect acting object, and displaying a second effect image in which the adjusted effect light rays act on the effect acting object.

13. A non-transitory storage medium comprising computer executable instructions, wherein the computer executable instructions, when executed by a computer processor cause a method for effect processing to be performed, and the method comprises:
in response to an effect triggering operation, obtaining an image to be processed, and displaying a first effect image in which a plurality of effect light rays divergently act on an effect acting object in the image to be processed; and
adjusting the effect light rays when change occurs for object display information of the effect acting object, and displaying a second effect image in which the adjusted effect light rays act on the effect acting object.

14. The electronic device according to claim 12, wherein the object display information comprises a rotation angle; and
the adjusting the effect light rays when change occurs for object display information of the effect acting object, comprises:
adjusting a diverging direction of the effect light rays when change occurs for a rotation angle of the effect acting object.

15. The electronic device according to claim 12, wherein the displaying a first effect image in which a plurality of effect light rays divergently act on an effect acting object in the image to be processed comprises:
for the image to be processed, determining a light emitting center point corresponding to the effect light rays, and determining edge pixels of the effect acting object in the image to be processed;
determining the diverging direction of each of the plurality of effect light rays based on the light emitting center point and the edge pixels; and
constructing the effect light rays based on the diverging direction of each effect light ray to obtain the first effect image in which the effect light rays act on the effect acting object in the image to be processed, and displaying the first effect image.

16. The electronic device according to claim 15, wherein the determining the diverging direction of each of the plurality of effect light rays based on the light emitting center point and the edge pixels comprises:
for each edge pixel to be processed of the edge pixels of the effect acting object, determining a three-dimensional center point coordinate of the light emitting center point and a three-dimensional edge point coordinate of the edge pixel; and
determining a diverging direction of an effect light ray corresponding to the edge pixel based on the three-dimensional center point coordinate and the three-dimensional edge point coordinate.

17. The electronic device according to claim 16, wherein the determining a three-dimensional center point coordinate of the light emitting center point and a three-dimensional edge point coordinate of the edge pixel, comprises:
when the image to be processed is a two-dimensional image, based on preset depth information, converting a two-dimensional center point coordinate of the light emitting center point to the three-dimensional center point coordinate, and converting a two-dimensional edge point coordinate of the edge pixel to the three-dimensional edge point coordinate.

18. The electronic device according to claim 16, wherein the constructing the effect light rays based on the diverging direction of each effect light ray comprises:
constructing the effect light ray along the diverging direction according to a preset initial light intensity and an attenuation factor corresponding to the light intensity, taking the edge pixel as a starting display position.

19. The electronic device according to claim 14, wherein the adjusting a diverging direction of the effect light rays comprises:
determining the rotation angle of the effect acting object, and determining a rotation matrix of the effect acting object in a three-dimensional space based on the rotation angle of the effect acting object; and
determining the adjusted diverging direction of the effect light ray according to a current diverging direction of the effect light rays and the rotation matrix.

20. The electronic device according to claim 19, wherein the determining the adjusted diverging direction of the effect light ray according to a current diverging direction of the effect light ray and the rotation matrix comprises:
when the image to be processed is a two-dimensional image, determining a direction vector of the current diverging direction of the effect light ray in the three-dimensional space; and
multiplying the direction vector by the rotation matrix to obtain an adjusted direction vector of the effect light ray, and mapping the direction vector to a two-dimensional space to obtain the diverging direction of the effect light ray.

21. The electronic device according to claim 12, wherein after the obtaining the image to be processed, the method for effect processing further comprises:
performing filtering processing on the image to be processed based on a guided filtering algorithm.
